(19) United States
(12) Patent Application Publication
(10) Pub. No.: US 2009/0136676 A1
(43) Pub. Date: May 28, 2009

(54) Method and Apparatus For Coating a Food Item

(76) Inventor: Michael Ching, Kapolei, HI (US)

Correspondence Address: Law Office of Wendell J. Jones, PMB 441, 555 Bryant Avenue, Palo Alto, CA, 94301, US

(21) Appl. No.: 12/192,115

(22) Filed: Aug. 14, 2008

Related U.S. Application Data
(60) Provisional application No. 60/964,869, filed on Aug. 14, 2007.

(51) Int. Cl. B05D 1/18; A23G 3/24

(52) U.S. Cl. 427/430.1; 118/30

(57) ABSTRACT

An apparatus for coating at least one food item is disclosed. The apparatus includes a reservoir for housing a liquid medium, a dipping assembly operatively coupled to the reservoir wherein the dipping assembly includes a holding mechanism for holding the at least one food item, and mechanical means operatively coupled to the holding mechanism for moving the holding mechanism into the reservoir whereby the at least one food item is immersed in the liquid medium such that the at least one food item is partially coated with the liquid medium in a predetermined fashion.

### CROSS-REFERENCE TO RELATED APPLICATIONS

This application is related to and claims priority from U.S. Provisional Patent Application Ser. No. 60/964,869 filed Aug. 14, 2007.

### BACKGROUND

Many people enjoy eating sweets, and in particular cookies. Each year in the United States alone many billions of dollars worth of cookies are consumed by the public. One variety of cookies that are of particular interest are cookies coated with confectionary products such as chocolate, frosting, etc.

A problem exists however in manufacturing these coated cookies. If a particular coated pattern is desired, a worker has to manual coat each individual cookie in the desired coated pattern. For example, if a particular pattern of chocolate coating is desired, a worker must hand-dip each cookie into a vat of melted chocolate. The chocolate is then allowed to dry and harden before the final product can be packaged and shipped for sale and consumption. This is an extremely slow and tedious process.

### SUMMARY

The present invention includes a method and apparatus for coating a plurality of food items. A first aspect includes a method of coating a plurality of food items the method includes affixing the plurality of food items to a holding mechanism and immersing the plurality of food items in a liquid medium whereby each of the plurality of food items are partially coated in a predetermined fashion.

A second aspect includes an apparatus for coating at least one food item. The apparatus includes a reservoir for housing a liquid medium, a dipping assembly operatively coupled to the reservoir wherein the dipping assembly includes a holding mechanism for holding the at least one food item, and mechanical means operatively coupled to the holding mechanism for moving the holding mechanism into the reservoir whereby the at least one food item is immersed in the liquid medium such that the at least one food item is partially coated with the liquid medium in a predetermined fashion.

A third aspect includes an apparatus for coating a plurality of food items with a liquid medium. The apparatus includes a reservoir for housing the liquid medium, an agitation mechanism for agitating the liquid medium, a dipping assembly operatively coupled to the reservoir wherein the dipping assembly includes a holding mechanism for holding the plurality of food items and mechanical means operatively coupled to the holding mechanism for moving the holding mechanism into the reservoir whereby the plurality of food items are immersed in the liquid medium such that each of the plurality of food items is partially coated with the liquid medium in a predetermined fashion.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high-level flowchart of a method in accordance with an embodiment of the present invention.

FIG. 2 illustrates an apparatus in accordance with an embodiment of the present invention.

FIG. 3 illustrates a dipping assembly in accordance with an embodiment of the present invention.

### DETAILED DESCRIPTION

A method and apparatus for an apparatus for coating at least one food item is disclosed. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

In varying embodiments, the method and apparatus allows a plurality of food items to be simultaneously coated with a liquid medium in a predetermined, uniform fashion. Through the use of the method and apparatus in accordance with the present invention, a large number of food items and the like can be coated quickly and uniformly thereby increasing the manufacturing throughput of the coated food items.

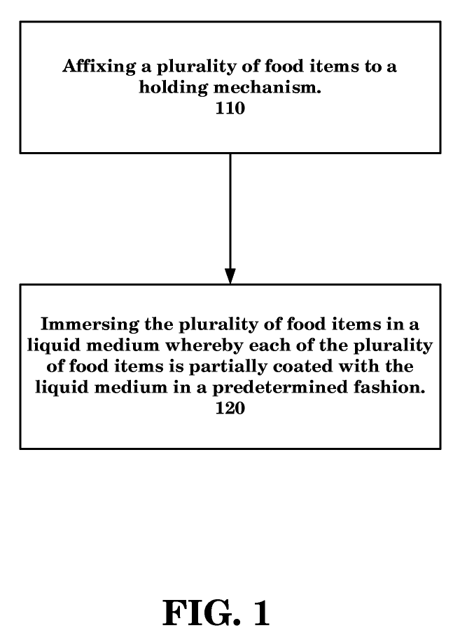

FIG. 1 is a flowchart of a method in accordance with an embodiment. A first step 110 involves affixing the plurality of food items to a holding mechanism. A final step 120 includes immersing the plurality of food items in a liquid medium whereby each of the plurality of food items are partially coated with the liquid medium in a predetermined fashion.

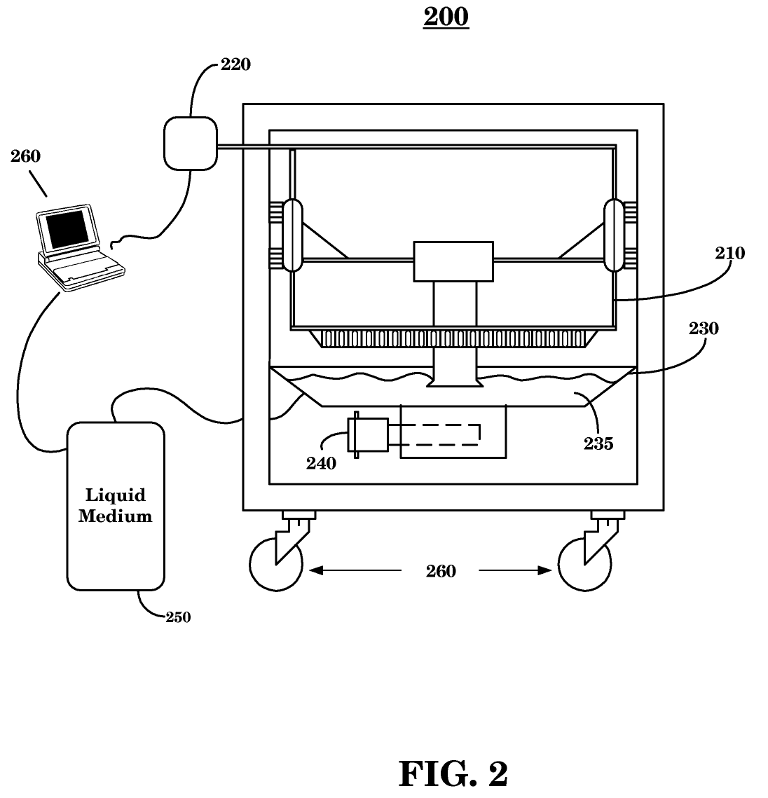

FIG. 2 high-level illustration of an apparatus 200 in accordance with an embodiment. The apparatus includes a dipping assembly 210 operatively coupled to a motor 220. The apparatus 200 further includes a reservoir 230 for housing a liquid medium 235. The liquid medium 235 is provided by a storage tank 250 coupled to the reservoir 230 via a feed line 245. Also shown is a heating mechanism 240 operatively coupled to the reservoir 230 for heating the liquid medium 235. Additionally, for mobility, the apparatus 200 further includes a group of wheel assemblies 260.

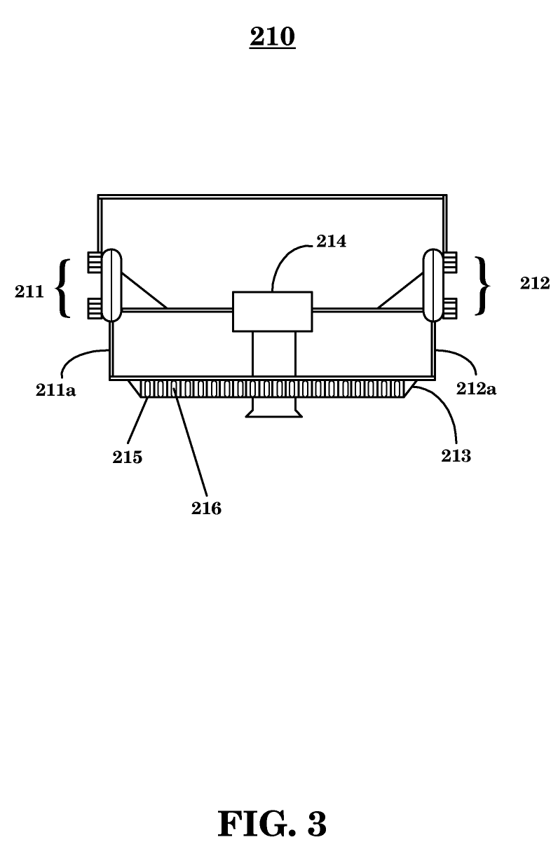

For a better understanding of the dipping assembly 210 please refer to FIG. 3. The dipping assembly 210 includes two mechanical means 211, 212 coupled to both sides of a holding mechanism 213 via connecting rods 211a, 212a. The holding mechanism 213 includes a plurality of individual holders 215 each configured to hold a food item 216. For example, the individual holders could be configured to hold a cookie, an item of fruit (strawberry, mango, etc.) or the like. Also shown is an agitation mechanism 214 operatively coupled to the mechanical means 211, 212 for agitating the liquid medium. Use of the agitation mechanism 214 helps maintain the consistency of the liquid medium.

Although the holding mechanism 213 is described in the context of holding a cookie or an item of fruit, one of ordinary skill in the art will readily recognize that a variety of different items could be employed in conjunction with the holding mechanism while remaining within the spirit and scope of the present inventive concepts.

In an embodiment, the mechanical means 211, 212, in conjunction with the motor 220, facilitate an “up and down” positioning sequence of the holding mechanism 213. In the “up” position, the holding mechanism 213 is not in contact with the liquid medium, thereby facilitating the loading and/or removal of food items. Consequently, when actuated by the motor 220, the mechanical means 211, 212 lower the holding mechanism 213 to a “down” position, whereby the holding mechanism 213 is lowered into the liquid medium.

During operation of the apparatus 200, a plurality of food items, for example, cookies, are loaded into the holding mechanism 213 while the holding mechanism 213 is in the “up” position. Once loaded, the mechanical means 211, 212 are actuated via the motor 220 to move to the down position whereby the loaded cookies are coated with the liquid medium (e.g. melted chocolate) in a predetermined fashion. In an embodiment, substantially one-half of each of the cookies are coated with the melted chocolate however, any of a variety of predetermined patterns could be employed. Once coated, the mechanical means 211, 212 are actuated again to move the holding mechanism 213 into the up position thereby facilitating the removal of the chocolate coated cookies. Once removed, the chocolate-coated cookies are allowed to dry, after which they are packaged and shipped to various locations.

Referring back to FIG. 2, the apparatus 200 components can be constructed out of stainless steel, aluminum or any of a variety of other materials that are resistant to rust and can be easily cleaned and maintained. Additionally a control system 260 could be employed in conjunction with the storage tank 250, the motor 220, the heating mechanism 240, the agitation mechanism 214, etc. For example, in order to keep the liquid medium 235, e.g. melted chocolate, at the appropriate level and temperature, a control system 220 could be employed to monitor the level of melted chocolate in the reservoir 230 based on the number of food items being coated. For example, when X number of food items are coated, Y amount of chocolate is added to the reservoir 230 to maintain a desired level of melted chocolate in the reservoir 230. The control system 220 could be a computer system or the like.

The control system 220 could also be employed to control the consistency of the chocolate by monitoring the heating mechanism 240 and the agitation mechanism 214 in conjunction with the amount of chocolate in the reservoir 230. For example, if a specific consistency of melted chocolate is desired, the heating mechanism 240 can be utilized to raise or lower the temperature while simultaneously adjusting the speed of the agitation mechanism 214 to achieve the desired consistency of melted chocolate.

Although the above-described embodiments are disclosed in the context of utilizing melted chocolate as the liquid medium, one of ordinary skill in the art will readily recognize that a variety of mediums could be employed while remaining within the spirit and scope of the presently described inventive concepts.

Varying embodiments of the present invention includes a method and apparatus for coating a plurality of food items. Through the use of the method and apparatus in accordance with the present invention, a large number of food items and the like can be coated quickly and uniformly thereby increasing the manufacturing throughput of the coated food items. This results in an increase in shipped product(s) thereby resulting in a substantially higher number of overall products being sold.

Without further analysis, the foregoing so fully reveals the gist of the present inventive concepts that others can, by applying current knowledge, readily adapt it for various applications without omitting features that, from the standpoint of prior art, fairly constitute the characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. An apparatus for coating at least one food item comprising:
a reservoir for housing a liquid medium;
a dipping assembly operatively coupled to the reservoir wherein the dipping assembly comprises
a holding mechanism for holding the at least one food item; and
mechanical means operatively coupled to the holding mechanism for moving the holding mechanism into the reservoir whereby the at least one food item is immersed in the liquid medium such that the at least one food item is partially coated with the liquid medium in a predetermined fashion.

2. The apparatus of claim 1 wherein the at least one food item comprises a cookie.

3. The apparatus of claim 1 wherein the at least one food item comprises a fruit item.

4. The apparatus of claim 3 wherein the fruit item comprises at least one of a strawberry and a mango.

5. The apparatus of claim 1 wherein the dipping assembly further comprises an agitation mechanism operatively coupled to the mechanical means for agitating the liquid medium.

6. The apparatus of claim 5 further comprising a heating mechanism operatively coupled to the reservoir for heating the liquid medium.

7. The apparatus of claim 1 wherein the liquid medium comprises chocolate.

8. The apparatus of claim 1 wherein the holding mechanism is configured to hold a plurality of food items.

9. The apparatus of claim 1 further comprising a control system operatively coupled the dipping assembly for controlling the movement thereof.

10. A method of coating a plurality of food items comprising:
affixing the plurality of food items to a holding mechanism; and
immersing the plurality of food items in a liquid medium whereby each of the plurality of food items are partially coated in a predetermined fashion.

11. The method of claim 10 wherein the plurality of food items comprises a plurality of cookies.

12. The method of claim 10 wherein the plurality of food items comprises a plurality of fruit.

13. The method of claim 10 wherein the liquid medium comprises chocolate.

14. An apparatus for coating a plurality of food items with a liquid medium comprising:
a reservoir for housing the liquid medium;
an agitation mechanism for agitating the liquid medium
a dipping assembly operatively coupled to the reservoir wherein the dipping assembly comprises
a holding mechanism for holding the plurality of food items; and
mechanical means operatively coupled to the holding mechanism for moving the holding mechanism into the reservoir whereby the plurality of food items are immersed in the liquid medium such that each of the plurality of food items is partially coated with the liquid medium in a predetermined fashion.

15. The apparatus of claim 14 wherein the plurality of food items comprises a plurality of cookies.

16. The apparatus of claim 14 wherein the plurality of food items comprises a plurality of fruit.

17. The apparatus of claim 14 wherein the liquid medium comprises chocolate.

18. The apparatus of claim 14 further comprising a heating mechanism operatively coupled to the reservoir for heating the liquid medium.

19. The apparatus of claim 14 further comprising a control system operatively coupled the dipping assembly for controlling the movement thereof.
